(19) United States
(12) Patent Application Publication
(10) Pub. No.: US 2023/0350473 A1
(43) Pub. Date: Nov. 2, 2023

(54) COMPUTER POWER CONSUMPTION MANAGEMENT BASED ON THE STATE OF THE POWER SUPPLYING ELECTRICAL GRID

(71) Applicant: DC Systems B.V., Aalsmeer (NL)

(72) Inventor: Henricus David Stokman, Aalsmeer (NL)

(73) Assignee: DC Systems B.V., Aalsmeer (NL)

(21) Appl. No.: 18/134,612

(22) Filed: Apr. 14, 2023

(30) Foreign Application Priority Data
Apr. 27, 2022 (EP) 22170182.4

(51) Int. Cl. G06F 1/26; H02J 1/08; H02J 1/10

(52) U.S. Cl. CPC G06F 1/26; H02J 1/08; H02J 1/10

(57) ABSTRACT

A method of adapting the power consumption of a computer, which is supplied with power from a power bus of an external electrical grid, to the power available from the power bus, wherein the computer has a processor configured for executing computing tasks, and wherein the power bus is either an AC bus or a DC bus. The method includes measuring the frequency F on the power bus in case of an AC power bus, or the voltage U on the power bus in case of a DC power bus, thus obtaining a power supply measurement indicative of the level of power supply from the power bus; and adapting the processor's computing task execution based on the obtained power supply measurement to thus maintain, increase, or reduce the computer's power consumption.

### TECHNICAL FIELD

This disclosure generally pertains to the field of electricity supply for digital electronic computers. More specifically, the focus is on matching the electrical power consumed by a digital electronic computer with the electrical power available to the computer from an external power source.

One important application of the present disclosure is to the management of server loads in data centres.

### BACKGROUND ART

The article “Towards green data center microgrids by leveraging data center loads in providing frequency regulation” by W. Qi et al., published in 2019 in Scientia Iranica D, 26(6), pp. 3559-3570, proposes a load control strategy for data centre microgrids. In this control strategy, flexibilities of the data centre's computing servers in processing delay-tolerant tasks are leveraged to control the data centre's power consumption and thus regulate the AC power frequency of the data centre microgrid.

The control strategy is explained in section 3 of the article, starting on page 3564, and illustrated by the article's FIG. 7: the AC power frequency at the point of common coupling of the data centre microgrid is constantly monitored, and, if the frequency drops too much below a reference frequency, computing servers in the data centre are switched off to reduce the load on the microgrid.

The sole aim of this known data centre power management scheme is to keep the AC power supply frequency within a corridor around the normal operating frequency (e.g., 60 Hz). This is to ensure the stability and security of the whole microgrid.

A drawback of this scheme is its considerable negative impact on the performance of the data centre's computing servers. Indeed, each time there is a power shortage, whole server clusters are shut down.

### SUMMARY

In view of the above, it is an object of the present disclosure to provide an improved method of adapting the power consumption of computers, and in particular of servers, in electrical grids to the varying power supply levels in the electrical grid.

According to the present disclosure, this object is achieved with a method of adapting the electrical power consumption of a digital electronic computer, which is supplied with electrical power from a power bus of an external electrical grid, to the instantaneous electrical power available from the power bus, wherein the digital electronic computer has a processing unit, the processing unit being configured for executing computing tasks, and wherein the power bus is either an AC bus providing AC electrical power at an electrical frequency F, or a DC bus providing DC electrical power at an electrical voltage U, the method comprising the following steps: a. measuring the instantaneous electrical frequency F on the power bus in case of an AC power bus, or the instantaneous electrical voltage U on the power bus in case of a DC power bus, thus obtaining a power supply measurement indicative of the instantaneous level of power supply from the power bus, and b. adapting the processing unit's computing task execution based on the obtained power supply measurement to thus maintain, increase, or reduce the computer's electrical power consumption.

In other words, the way the computer's processing unit executes tasks is made dependent on the current power state of the external electrical grid. Depending on the power available from the external electrical grid, the processing unit will perform more or less tasks, execute tasks more slowly, or execute tasks more quickly. Accordingly, the IT load on the electrical grid can be adapted much more precisely and dynamically. In particular, the IT load can be modified in small increments by increasing or reducing the task execution of the processing unit.

In contrast to the control strategy of the above-mentioned article, the method of the present disclosure follows a bottom-up approach. In the case of a data centre grid, according to the present disclosure, each computing server does its own individual and independent load management. In other words, the load controlling task is distributed over all the different computing servers.

According to the present disclosure, it is the individual computer that monitors the health of the external electrical grid and that adapts its consumption accordingly. If there is plenty of power available from the electrical grid, the computer will run its processing unit at maximum capacity. On the other hand, if there is a power shortage on the electrical grid, the computer will throttle its processing unit down.

The following features can be optionally implemented, separately or in combination one with the others:
step b includes the following step b1: if the power supply measurement falls below a predetermined throttling threshold associated with one or more tasks currently executed by the processing unit, less of the processing unit's resources are allocated to the associated one or more tasks to reduce the processing unit's power consumption;
in step b1, the allocation of less resources increases linearly as the power supply measurement continues to decrease below the predetermined throttling threshold;
in step b, if the power supply measurement falls to a predetermined lower ending threshold associated with one or more tasks currently executed by the processing unit, the associated one or more tasks are ended;
after step a and prior to step b, the step of deriving a power supply level indicator, which indicates the instantaneous level of the power supply from the power bus, from the obtained power supply measurement, and wherein, in step b, the derived power supply level indicator is used as a reference to adapt the computing task execution of the processing unit;
step b includes the following step b1: if the power supply level indicator falls below a predetermined throttling threshold associated with one or more tasks currently executed by the processing unit, less of the processing unit's resources are allocated to the associated one or more tasks to reduce the processing unit's power consumption;
in step b1, the allocation of less resources increases linearly as the power supply level indicator continues to decrease below the predetermined throttling threshold;
in step b, if the power supply level indicator falls to a predetermined lower ending threshold associated with one or more tasks currently executed by the processing unit, the associated one or more tasks are ended;
the digital electronic computer includes a task manager for managing the computing tasks executed by the processing unit, and step b is at least partly performed by the task manager;
the power bus is a DC bus, the power supply chain of the digital electronic computer includes a DC power supply unit, an input side of the DC power supply unit is electrically connected to the DC power bus, a voltage sensor is arranged at the input side of the DC power supply unit, and the voltage sensor is adapted for carrying out step a of the method.

The present disclosure also relates to a method of managing electrical power consumption in a data centre, the data centre including a plurality of computing servers and a power bus supplying electrical power to the computing servers, wherein the electrical power consumption of each computing server is adapted in accordance with the method as detailed above.

Optionally, in this power consumption managing method, step a is implemented as a central measurement operation, and the obtained power supply measurement is transmitted to each computing server to be used as a basis for the adaptation of the computing server's electrical power consumption.

### BRIEF DESCRIPTION OF DRAWINGS

Preferred embodiments of the present disclosure will now be described in detail with reference to the appended drawings, wherein:

FIG. 1 is a block diagram of a first data centre and its associated power sources according to the present disclosure.

FIG. 2 is a block diagram of a second data centre and its associated power sources according to the present disclosure.

FIG. 3 shows two sets of power curves illustrating how, according to the present disclosure, the electrical power consumption of the CPU of a computing server located in a data centre is adapted.

### DESCRIPTION OF EMBODIMENTS

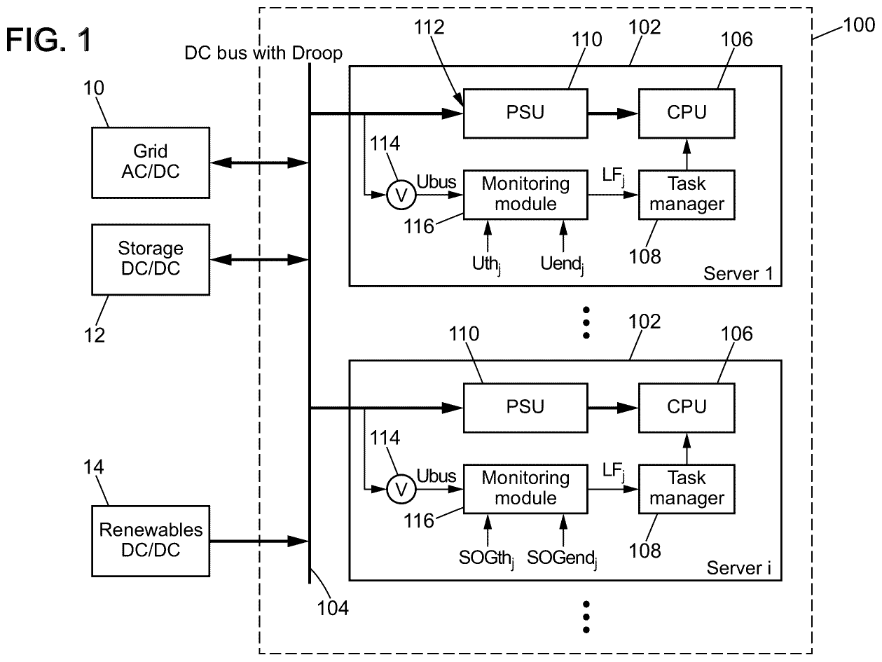

FIG. 1 shows a first data centre 100 according to the present disclosure.

Typically, datacentre 100 is an IT installation, which provides IT services such as data storage, data processing and computing to paying customers.

Datacentre 100 includes a plurality of computing servers 102 and a power bus 104, which supplies electrical power to the computing servers 102. The computing servers 102 handle the different IT services.

Only two servers, labelled “Server 1” and “Server i”, are shown in FIG. 1, but in practice datacentre 100 may contain thousands of servers 102.

The servers 102 are all digital electronic computers. As such, each server 102 comprises a processing unit 106.

Typically, the processing unit 106 is the server's central processing unit or CPU. However, it may also be a graphical processing unit (GPU), or another type of processing unit.

The processing unit 106 executes various computing tasks under the control of a task manager 108, which is also part of the server 102.

The task manager 108 manages the computing tasks executed by the processing unit 106. In particular, the task manager 108 may allocate new tasks to the processing unit 106, may end the execution of tasks by the processing unit 106, or may change the allocation of the processing unit's resources to the various tasks. By doing so, task manager 108 may speed up or slow down the execution of specific tasks. The task manager 108 may be implemented in the server 102 as a hardware and/or software module.

In the present example, each server 102 also comprises a DC power supply unit or PSU 110. The PSU 110 is a DC-to-DC converter, which converts the higher electrical voltage of the DC bus 104 to the lower electrical voltage needed by the server 102. As shown in FIG. 1, the PSU 110 provides power to the processing unit 106, and also to other components of the server 102.

An input side 112 of the PSU 110 is electrically connected to the DC power bus 104.

A voltage sensor 114 is arranged at the input side 112 of the PSU 110. Here, the voltage sensor 114 is part of the server 102. However, alternatively, both the PSU 110 and the voltage sensor 114 may be located outside the server 102. In this case, the PSU 110 may be implemented as a separate device between the DC power bus 104 and the server 102.

Each server 102 also includes a monitoring module 116. The monitoring module 116 may be implemented as hardware, for example, in the form of a logic circuit, or as a software module.

The monitoring module 116 receives as an input a voltage measurement Ubus, which is output by the voltage sensor 114.

The output of the monitoring module 116 is a set of load factors LFⱼ, which are sent to the task manager 108. The role of the monitoring module 116 is to constantly monitor the evolution of the voltage Ubus on the DC bus 104 and to tell the task manager 108 via the load factors LFⱼ when and how to throttle down the various tasks carried out by the CPU 106.

In the present example, the electrical power available from the power bus 104 is provided by three different power sources 10, 12 and 14. Power source 10 corresponds to the public AC electricity network. Power source 12 is an electrical battery. Power source 14 is a renewable energy source such as a solar panel array.

As apparent from FIG. 1, the power sources 10, 12 and 14, the DC bus 104 and the respective power supply unit 110 together form a power supply chain for each server 102 of the data centre 100.

As seen from the servers 102, the DC power bus 104 and the power sources 10, 12 and 14 together form an external electrical grid, and the servers 102 are connected thereto.

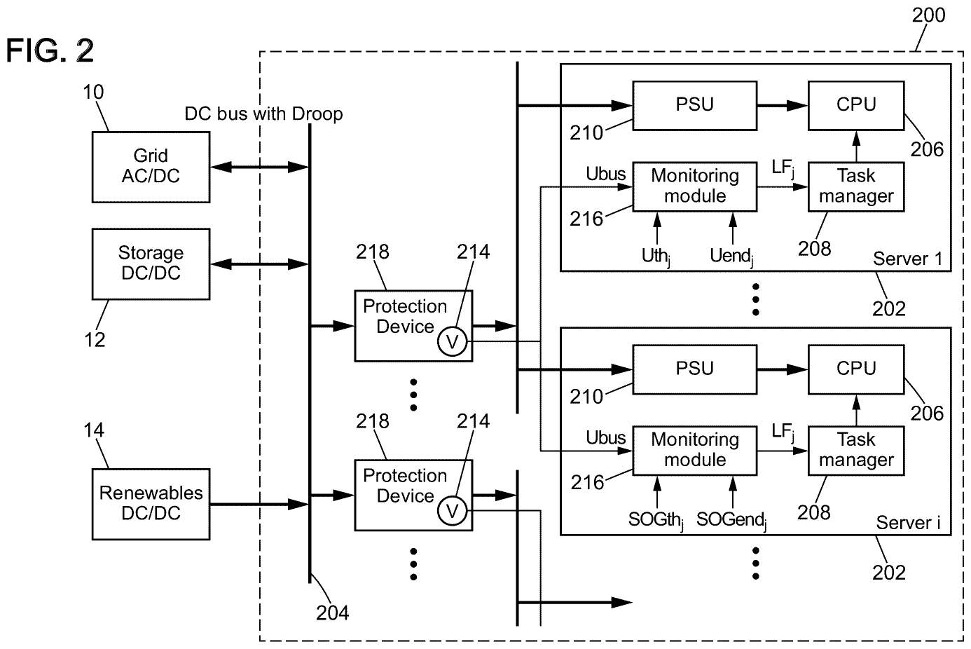

The electrical systems shown in FIGS. 1 and 2 are direct current (DC) systems. However, the present disclosure equally applies to comparable alternating current systems, wherein the power bus 104/204 is an alternating current (AC) bus, and the voltage sensors 114/214 are replaced by frequency sensors that measure the instantaneous electrical frequency on the AC power bus.

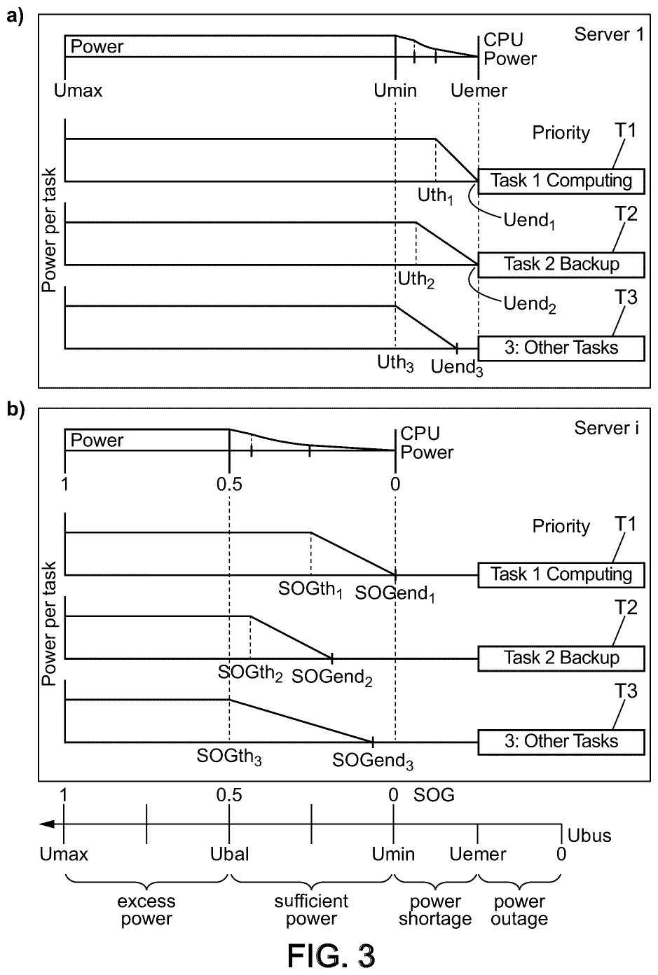

With reference to FIGS. 1 and 3, we will now describe how, according to the present disclosure, the electrical power consumption of the servers 102 is adapted as a function of the electrical power available from the DC power bus 104.

In the exemplary method illustrated by FIGS. 1 and 3, the general control strategy is to throttle down the task execution by the CPUs 106 when there is a power shortage on the DC bus 104. This has a stabilising effect on the bus voltage Ubus and helps to reduce imbalances between the power drawn by the datacentre 100 and the power generated by the power sources 10, 12 and 14.

The amount of power available from the DC power bus 104 correlates with the electrical voltage Ubus on the power bus. The higher the voltage Ubus, the higher the available power. Conversely, if the bus voltage Ubus is low, then there is not much power available from the DC power bus 104.

A droop control ensures that the voltage Ubus on the DC power bus 104 remains between an upper limit U maximum (Umax) and a lower limit U emergency (Uemer). This voltage corridor is illustrated by the voltage scale at the bottom of FIG. 3. The bus voltage Ubus must not fall below the emergency voltage Uemer prevent a power outage in the data centre 100. The bus voltage Ubus also must not be higher than the maximum voltage Umax to prevent a power flood, which might damage the installations in the data centre 100.

Inside the voltage corridor delimited by Umax and Uemer there are two intermediate voltages U balance (Ubal) and U minimum (Umin). The voltage Ubal is the optimum voltage for the DC power bus 104. At this voltage, there is a balance between the power generated by the power sources 10, 12 and 14 and the power consumed by the data centre 100. The minimum voltage Umin is a lower limit above the critical lower limit Uemer. When the bus voltage Ubus falls below the minimum voltage Umin but is still above the critical voltage Uemer there is a power shortage on the DC power bus 104. This should be avoided, but the data centre 100 can still operate in limited power mode. If the bus voltage Ubus falls below the critical limit Uemer the power shortage becomes a power outage and installations in the data centre 100 will start shutting down uncontrollably. Accordingly, the electrical system shown in FIG. 1, which includes the power sources 10, 12 and 14, the DC power bus 104 and the servers 102 should be controlled in such a way as to maintain the bus voltage Ubus between Umax and Umin. Exceptionally, the bus voltage Ubus may fall below Umin, but it must not fall below Uemer.

In the embodiment of FIGS. 1 and 3, each server 102 has a voltage sensor 114 so that it can constantly monitor the bus voltage and thus the power level on the DC power bus 104. If the bus voltage falls below the optimum voltage Ubal this will be noticed by each server 102. Each server may then start to slow down the task execution by its CPU 106 to stabilise the bus voltage Ubus. On the other hand, if the bus voltage Ubus exceeds Ubal, then each server 102 may speed up the task execution by its CPU 106 and/or assign additional tasks to its CPU 106.

In other words, the voltage sensors 114 measure the instantaneous electrical voltage Ubus on the power bus 104 and thus obtain a power supply measurement indicative of the instantaneous level of power supply from the power bus 104. Subsequently, the computing task execution of each processing unit 106 is adapted based on the obtained power supply measurement Ubus to thus maintain, increase, or reduce the servers' electrical power consumption.

More precisely, in each task manager 108, the tasks executed by the associated CPU 106 are ranked according to priority. With reference to FIG. 3, the CPU of the first server “Server 1” and the CPU of the ith server “Server i” may each run a first task T1 labelled “Task 1”, which is a computing task, and which has highest priority, a second task T2 labelled “Task 2”, which is a backup task and has the second highest priority, and a set of other tasks T3, which have the lowest priority.

We will now first focus on the task throttling strategy implemented in Server 1. This strategy is illustrated by FIG. 3a.

The uppermost graph in FIG. 3a shows how the power consumption of the CPU varies as a function of the bus voltage Ubus measured by the voltage sensor 114. One can see that, between Umax and Umin, the CPU runs at full power. However, if the bus voltage Ubus falls below Umin, the CPU is throttled down linearly. If the bus voltage Ubus falls to the emergency voltage Uemer then the CPU is switched off completely.

The throttling down of the CPU between Umin and Uemer is a combined result of the throttling down of the computing task T1, the backup task T2 and the other tasks T3.

The task throttling is implemented as follows: two voltage thresholds Uthⱼ and Uendⱼ are associated with each task or group of tasks j with the same priority. The first voltage threshold Uthⱼ, called a throttling threshold, is the voltage below which the task or group of tasks j is throttled down. The second lower voltage threshold Uendⱼ, called an ending threshold, is the voltage at which the task or group of tasks j is ended. If the power supply measurement Ubus falls below the throttling threshold Uthⱼ less of the processing unit's resources are allocated to the associated task or group of tasks j to reduce the processing unit's power consumption. Preferably, as can be seen in FIG. 3a, the allocation of resources to the task or group of tasks j decreases linearly as the power supply measurement Ubus continues to decrease below the throttling threshold Uthⱼ.

If the power supply measurement Ubus falls to the lower ending threshold Uendⱼ the associated task or group of tasks is ended.

For each task or group of tasks j the two thresholds Uthⱼ and Uendⱼ are provided as input parameters to the monitoring module 116 (cf. FIG. 1). Based on the two input parameters Uthⱼ and Uendⱼ, as well as the bus voltage measurement Ubus, the monitoring module 116 calculates a load factor LFⱼ for each task or group of tasks j. The monitoring module 116 sends the calculated load factors LFⱼ to the task manager 108. Each load factor LFⱼ is a number between 1 and 0. Alternatively, the load factors LFⱼ may also be provided as percentage values between 100 and 0%. The task manager 108 instructs its CPU 106 to reduce the processing load of the task or group of tasks j by a factor which is given by the corresponding load factor LFⱼ. For example, if the load factor is 0.5 or 50% the corresponding task or group of tasks is run by the CPU 106 at half the normal load.

For each task or group of tasks j, the corresponding load factor LFⱼ may be calculated with the following two equations:

LFⱼ=1, if Ubus≤Uthⱼ (1)

LFⱼ=1−(Uthⱼ−Ubus)/(Uthⱼ−Uendⱼ), if Ubus<Uthⱼ (2)

According to the above equations, the load factor is equal to 1 if the voltage on the DC power bus 104 is greater than or equal to the throttling voltage Uthⱼ. This means that, as long as the bus voltage Ubus is above the throttling voltage of the corresponding task, the task runs at hundred percent.

However, if the voltage Ubus on the DC power bus 104 falls below the throttling voltage Uthⱼ, then the load factor LFⱼ falls below one. According to equation (2) above, the load factor LFⱼ decreases linearly from 1 to 0 as the voltage Ubus on the DC power bus 104 drops from the throttling voltage Uthⱼ to the ending voltage Uendⱼ. The linear rate of decrease of the load factor LFⱼ depends on the difference between the throttling voltage Uthⱼ and the ending voltage Uendⱼ. The closer the throttling voltage Uthⱼ to the ending voltage Uendⱼ, the higher the rate of decrease of the load factor LFⱼ. The value of the throttling voltage Uthⱼ, of the ending voltage Uendⱼ and thus the difference between the two will be chosen in accordance with the priority of the corresponding task or group of tasks j. This is illustrated by FIG. 3a: task T1 with the highest priority has an ending voltage Uend₁ which is equal to the emergency voltage Uemer, and its throttling voltage Uth₁ is close to the ending voltage Uend₁.

Task T2 with lower priority has the same ending voltage as task T1. However, the difference between the throttling voltage Uth₂ and the ending voltage Uend₂ is larger so that task T2 will be throttled down earlier than task T1. The other tasks T3 with the lowest priority have an ending voltage Uend₃, which is higher than the ending voltage of tasks T1 and T2. Furthermore, the throttling voltage Uth₃ of the other tasks T3 is the highest and set at the minimum voltage Umin.

In the just described strategy to control the power consumption of the servers 102 the calculation of the load factors LFⱼ is directly based on the voltage measurements Ubus provided by the voltage sensors 114. However, alternatively, as described in detail below, instead of directly using the voltage measurement for the load factor calculation, one may also first derive a power supply level indicator SOG from the power supply measurement Ubus and then calculate the load factors using the derived power supply level indicator SOG.

As used here, the indicator SOG indicates the instantaneous level of the power supply from the power bus 104. The indicator SOG is a proxy for the state of the external electrical grid, hence the acronym SOG, which stands for State Of the Grid.

The following equation is an example of how the indicator SOG may be calculated:

SOG=(Ubus−Umin)/(Umax−Umin) (3)

According to equation (3), SOG is a linear function of the bus voltage Ubus. Also according to equation (3), the indicator SOG will be a number between 0 and 1 since the bus voltage Ubus can only vary between the upper limit Umax and the lower limit Umin.

In equation (3) above, Umin may be replaced by Uemer in a setup where the bus voltage Ubus may be allowed to drop as low as the emergency voltage Uemer.

Using the above defined SOG indicator has the advantage that the amount of power currently available from the power bus 104 can be directly ascertained from the indicator. Indeed, if the SOG indicator is close to 0 then there is very little power available. If the SOG indicator is close to 1 then there is plenty of power available.

Estimating the available power from the voltage measurement Ubus is less straightforward since it requires knowledge about the operating parameters of the DC bus 104, namely Umax and Umin.

When using the power supply level indicator SOG, the two thresholds for each task or group of tasks j are indicator thresholds and not voltage thresholds. Each task or group of tasks j then has a throttling threshold SOGthⱼ and an ending threshold SOGendⱼ.

Equations (1) and (2) above then become:

LFⱼ=1, if SOG≥SOGthⱼ (4)

LFⱼ=1−(SOGthⱼ−SOG)/(SOGthⱼ−SOGendⱼ), if SOG<SOGthⱼ (5)

Task throttling based on the indicator SOG is illustrated by the graphs of FIG. 3b.

FIG. 3b illustrates the task throttling strategy implemented in server i whereas FIG. 3a illustrates the task throttling strategy implemented in server 1. Comparing the two, one can see that in server i all tasks are terminated when the indicator SOG is equal to 0, i.e., when the bus voltage has dropped to Umin. In server 1 however, tasks with high priority such as tasks T1 and T2 may still run to some extent until the bus voltage has dropped to the emergency voltage Uemer, which is lower than Umin.

The task throttling strategy shown in FIG. 3a may be applied in a server which is rented by a premium client, i.e., a client of the data centre who pays a premium price, so that its computing tasks keep running, even if the data centre 100 suffers a power shortage.

The task throttling strategy of FIG. 3b may be applied in a server rented by a standard client.

With reference to FIG. 2, the electrical power consumption management method of the present disclosure may also be applied to a data centre 200, which is equipped with protection devices 218. The protection devices 218 are arranged between the DC power bus 204 and the servers 202. The protection devices 218 are electrical, electromechanical, or electronic components which interrupt the power supply to the associated servers 202 in case of a fault in the electrical grid, such as a short circuit.

In the data centre 200, the voltage sensors 214, which measure the voltage on the DC bus 204, are in the protection devices 218. Accordingly, in the data centre 200, the bus voltage Ubus is measured centrally at each protection device 218, and the obtained power supply measurements Ubus are transmitted to each computing server 202 to be used as a basis for the adaptation of the computing servers' electrical power consumption.

In the data centre 200, since the voltage measurements are transmitted from a central location 218 to the individual servers 202, it is possible to make the power management even more versatile. For example, it is possible to transmit a virtual voltage value to one of the servers 202 instead of the real bus voltage Ubus. This virtual voltage value may, for example, be equal to Umax and may be transmitted to a high priority server. Accordingly, the server will keep on running at full load, even if the real bus voltage Ubus is low.

In a further variant, each server 202 may have its own associated local voltage sensor (as shown in FIG. 1) in addition to the central voltage sensors 214. These additional local voltage sensors can act as a backup if the transmission of the voltage measurements from the central voltage sensors 214 fails.

The above description and the figures relate to data centres equipped with a DC power bus. However, the present disclosure is equally applicable to data centres with AC power buses. In this case, it is the instantaneous electrical frequency F of the AC bus that is measured instead of the voltage. The measured electrical frequency F is used as a proxy for the electrical power available from the AC power bus and the task execution of the CPUs of the servers is adapted based on the frequency measurements.

1. A method of adapting the electrical power consumption of a digital electronic computer, which is supplied with electrical power from a power bus of an external electrical grid, to the instantaneous electrical power available from the power bus,
wherein the digital electronic computer has a processing unit, the processing unit being configured for executing computing tasks, and
wherein the power bus is either an AC bus providing AC electrical power at an electrical frequency F, or a DC bus providing DC electrical power at an electrical voltage U,
the method comprising the following steps:
a. measuring the instantaneous electrical frequency F on the power bus in case of an AC power bus, or the instantaneous electrical voltage U on the power bus in case of a DC power bus, thus obtaining a power supply measurement indicative of the instantaneous level of power supply from the power bus; and
b. adapting the processing unit's computing task execution based on the obtained power supply measurement to thus maintain, increase, or reduce the computer's electrical power consumption.

2. The method according to claim 1, wherein step b includes the following step:
b1. if the power supply measurement falls below a predetermined throttling threshold associated with one or more tasks currently executed by the processing unit, less of the processing unit's resources are allocated to the associated one or more tasks to reduce the processing unit's power consumption.

3. The method according to claim 2, wherein, in step b 1, the allocation of less resources increases linearly as the power supply measurement continues to decrease below the predetermined throttling threshold.

4. The method according to claim 1, wherein, in step b, if the power supply measurement falls to a predetermined lower ending threshold associated with one or more tasks currently executed by the processing unit the associated one or more tasks are ended.

5. The method according to claim 1, further comprising, after step a and prior to step b, the step of deriving a power supply level indicator, which indicates the instantaneous level of the power supply from the power bus, from the obtained power supply measurement, and wherein, in step b, the derived power supply level indicator is used as a reference to adapt the computing task execution of the processing unit.

6. The method according to claim 5, wherein step b includes the following step:
b1. if the power supply level indicator falls below a predetermined throttling threshold associated with one or more tasks currently executed by the processing unit, less of the processing unit's resources are allocated to the associated one or more tasks to reduce the processing unit's power consumption.

7. The method according to claim 6, wherein, in step b1, the allocation of less resources increases linearly as the power supply level indicator continues to decrease below the predetermined throttling threshold.

8. The method according to claim 5, wherein, in step b, if the power supply level indicator falls to a predetermined lower ending threshold associated with one or more tasks currently executed by the processing unit, the associated one or more tasks are ended.

9. The method according to claim 1, wherein the digital electronic computer includes a task manager for managing the computing tasks executed by the processing unit, and wherein step b is at least partly performed by the task manager.

10. The method according to claim 1, wherein:
the power bus is a DC bus;
the power supply chain of the digital electronic computer includes a DC power supply unit, an input side of the DC power supply unit being electrically connected to the DC power bus;
a voltage sensor is arranged at the input side of the DC power supply unit; and
the voltage sensor is adapted for carrying out step a of the method.

11. A method of managing electrical power consumption in a data centre, the data centre including a plurality of computing servers and a power bus supplying electrical power to the computing servers, wherein the electrical power consumption of each computing server is adapted in accordance with the method of claim 1.

12. The method according to claim 11, wherein step a is implemented as a central measurement operation, and wherein the obtained power supply measurement is transmitted to each computing server to be used as a basis for the adaptation of the computing server's electrical power consumption.
